(19) United States
(12) Patent Application Publication
(10) Pub. No.: US 2004/0057774 A1
(43) Pub. Date: Mar. 25, 2004

(54) Punchless file

(76) Inventor: Soon Huat Lim, Georgetown (MY)

Correspondence Address: SOON HUAT LIM, PLOT 16, BAYAN LEPAS FREE INDUSTRIAL, ZONE, PHASE 4, MK 12, BAYAN LEPAS, GEORGETOWN, 11900, MY

(21) Appl. No.: 10/273,841

(22) Filed: Oct. 21, 2002

(30) Foreign Application Priority Data
Sep. 25, 2002 (GB) GB 0222260.2

(51) Int. Cl. B42F 3/00

(52) U.S. Cl. 402/70

(57) ABSTRACT

There is disclosed a Punchless File whereby it is made of plastic injection and the accessories are made of plastic or metal. The size is made slightly larger than the size of the doc. A different size of doc will require a different size of the said invention. The invention has various devices to hold bulk doc together in a neat & organised manner without the use of ring fitting, lever arch mechanism or post fitting/mechanism for prepunch doc or punch pockets. The device and design include a stopper, a moveable guide, a side guide, separators, a drop down vertical side edge or a low vertical side edge & protrusions that lifts the bottom sheet of document up slightly for easy retrieval of doc. These devices act in part or in full to achieve the objective of this invention.

The Punchless File has also the ability to stand & stack. Stacking is secured by anti-slip male & female studs. When the file is closed, it forms a fully enclose case holding the doc inside, protecting these doc from the external environment such as water, etc. There are two locking devices secure the invention together.

### TECHNICAL FIELD

The present invention relates to file/binder.

### BACKGROUND ART

Conventional lever arch files, binders & ring files are usually used to hold doc (document/s) in bulk. They require doc to be prepunched to hold the doc in place. Punching these holes are troublesome & inconvenient to the user. Alternatively, these doc are put into punch pockets/sheet protectors & then placed into these files. This is also troublesome & expensive.

### SUMMARY OF INVENTION

The objective of this invention is to develop a file that can keep doc in bulk without the use of ring fitting, lever arch mechanism or any other post mechanism/fitting. Thus this will eliminate the neccesity to punch doc or the use of punch pocket for filing. It makes doc filing and retrieval easy & efficient. This invention is made from plastic injection and the accessories are made of plastic or metal.

This objective is attained by the following:

1. The size of the invention is made to be slightly larger than the size of the doc and has vertical edges(walls) on all 4 sides surrounding the doc concern. In so doing, the doc will not move freely within the confines of the invention. Thus, a different size of doc will require a different size of the said invention, ie. different sizes of invention are require for A4 doc (or thereabouts), F4 doc (or thereabouts), letter size doc (or thereabouts) &/or legal size doc (or thereabouts).

2. The stopper is developed to hold doc together in a pile & to prevent doc from moving through the depth of the invention. The stopper has spring tension which is sufficient to do as mention & yet the tension is light enough for the user to lift the stopper up to insert doc beneath it without the user feeling the hard stiffness of its spring effect.

3. The moveable guide is adjustable & rests against one side of the doc. The fixed side guide is on the other side of the doc. The doc is kept within these two guides which limit the movement of the doc sideways (widthwise).

4. The vertical edges (walls) of the invention will limit the movement of doc lengthwise.

5. Browsing through the doc. is easy & convenient. The invention is designed to have either a drop down vertical side edge or a low vertical side edge & room between this edge & the doc's edge so that the vertical side edge do not get in the way of the user's fingers when flicking the doc sheets. As the space between the doc edge & the vertical side edge is wide, the moveable guide is required to limit the movement of doc. The drop down vertical side edge is folded upwards to enable the invention to close together.

6. As the vertical edges of the invention are made low, a portion of the side guide is made higher than the vertical edge so as to guide a higher pile of doc. The high portion of the side guide is placed at the location where it does not get into the way of accessing the doc & still makes the invention aesthetic.

7. Another device, protrusions on the base of the invention facilitate the bottom sheet of doc to be easily retrieved. The protrusions are laid beneath & close to the side edge of the doc. This lifts the doc edge up slightly so as to allow the user's fingers to go underneath to pick the doc up.

8. The seperator device is used as a marker. After a particular doc is identified within the pile of doc, the seperator is used to mark the particular location of the targetted doc. The targetted doc is retrieved & subsequently, after usage, this doc is placed back in its original location with ease, since the seperator is still at this location. The seperator can be put aside when it is not in use.

9. The punchless file has also the ability to stand & stack. When the punchless file is closed up, the vertical edges shut together to form the horizontal flat bases on which the invention stands. Stacking is secured by anti-slip studs (male & female), on which the protrusion of the male stud sits into the depression of the female stud. This allows the invention to stack one after another, without sliding & toppling. These studs also grip the standing invention on its standing position.

10. When the invention is closed together, it forms a fully enclose case holding the doc inside, protecting these doc from the external environment such as water, etc. Two locking devices secure the punchless file together.

The above invention, coupled with the following features make the invention more user friendly:

a) the invention contains a label to depict the topic & contents of the file and/or;

b) the locking device allows colour coding of the invention and/or;

c) a handle is provided to enable handle carry, where necessary.

### SPECIFIC EXAMPLE

In order to allow the present invention more readily understood, the following description is given, by way of example, of specific embodiments of a file made in accordance with the present invention. Reference will be made to the accompanying drawing in which:

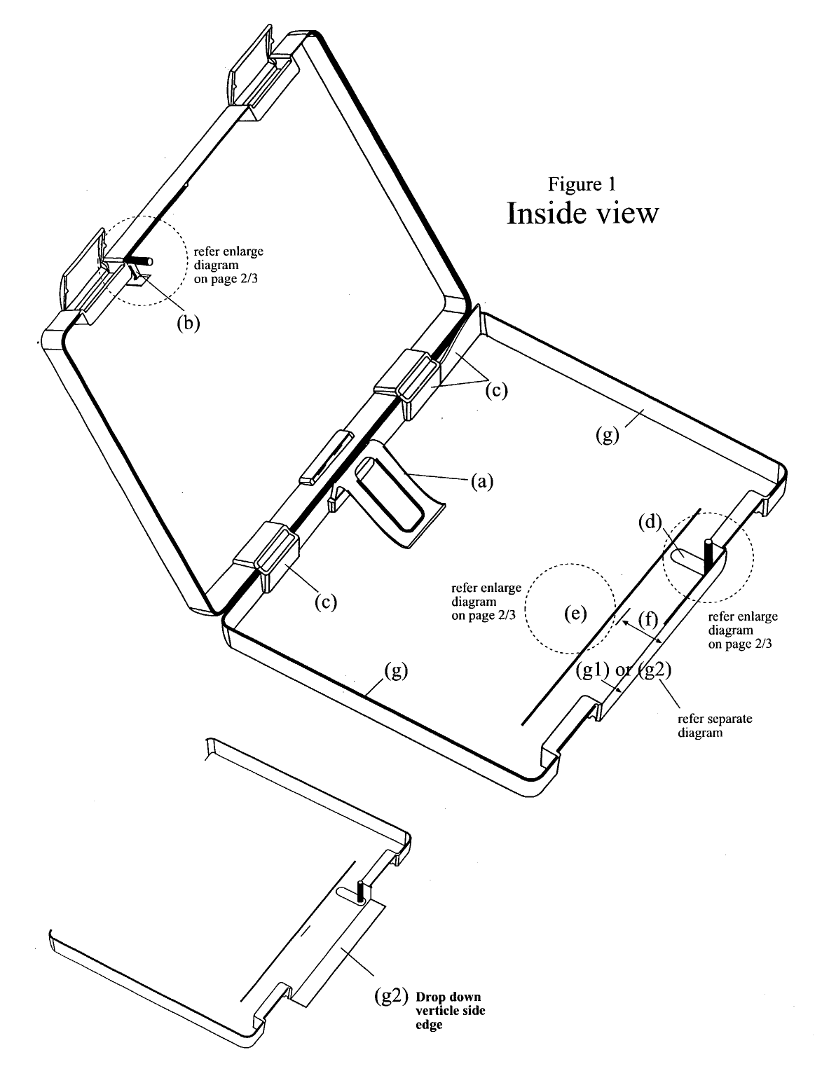

FIG. 1 shows the Inside View of the Punchless File

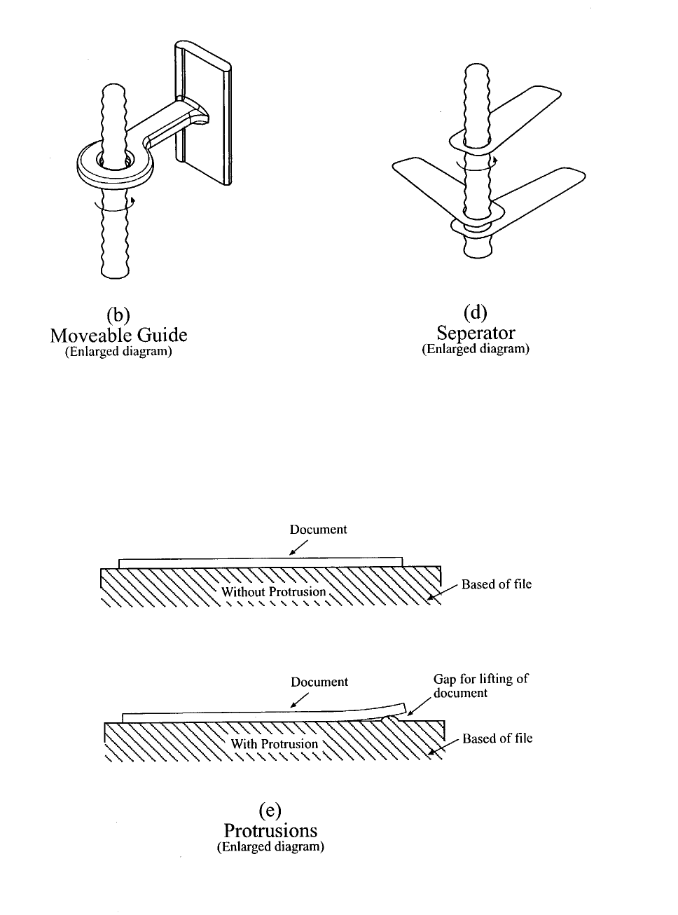

FIGS. 2a & 2b shows the Outside View of the Punchless File

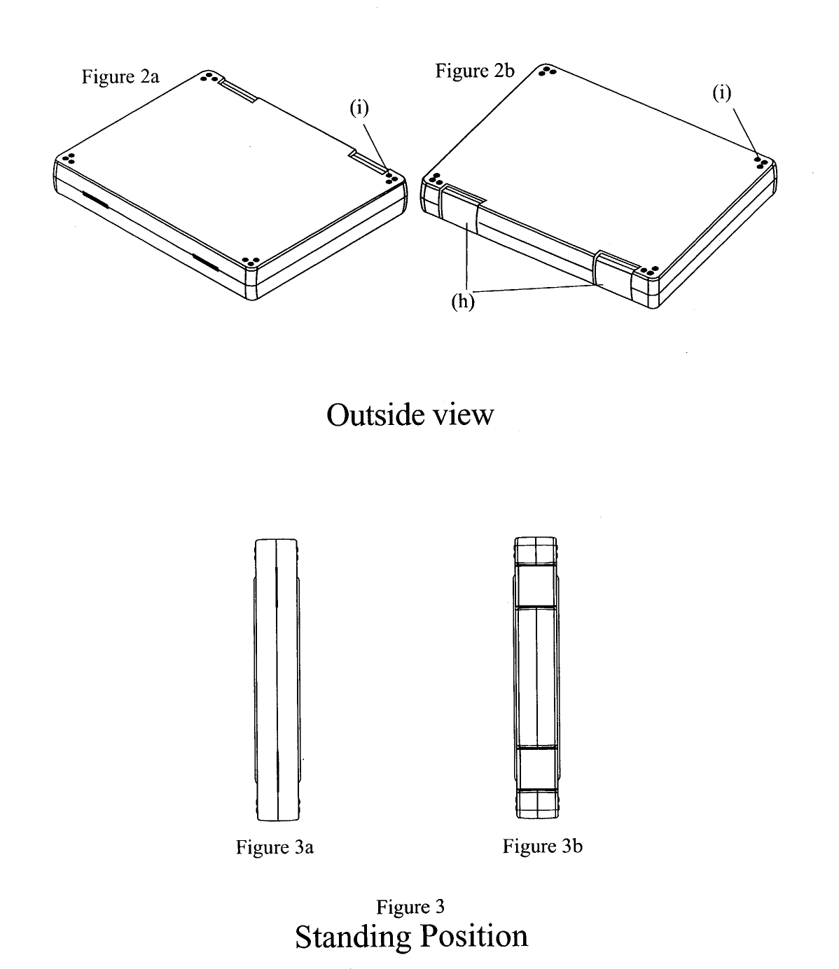

FIG. 3 shows the Standing Position of the Punchless File

A Punchless file is made from plastic injection and has various devices to hold bulk doc together in a neat & organized manner without the use of ring fitting, lever arch mechanism or post fitting/mechanism for prepunch doc or punch pockets.

These devices include a Stopper [FIG. 1—item (a)] which holds the doc together in a pile & stops the doc from moving through the depth of the invention. The stopper (a) has spring tension which is sufficient to do as mention & yet the tension is light enough for the user to lift the stopper up to insert doc beneath it without the user feeling the hard stiffness of its spring effect.

A Moveable Guide [FIG. 1—item (b)] is adjustable & rest against one side of the doc. The doc is kept within the moveable guide (b) & the side guide [FIG. 1—item (c)], thus limiting the movement of the doc sideways (widthwise). The Vertical Edges (walls) [FIG. 1—item (g)] will limit the movement of doc lengthwise.

Side Guide [FIG. 1—item (c)] is fixed & guides one edge of the doc. A portion of the side guide (c) is made higher than the vertical edges (g) of the invention so as to guide a higher pile of doc. The high portion of the side guide (c) is placed at the location where it does not get into the way of accessing the doc & still makes the invention aesthetic.

A Seperator [FIG. 1—item (d)] is used as a marker when required, to mark the location of the targetted doc within the pile of doc. The targetted doc is retrieved & subsequently, after usage is put back in its original location with ease, since the seperator (d) is still at this location. The seperator (d) can be put aside when not in use.

Another device, Protrusions [FIG. 1—item (e)] on the base of the invention facilitate the bottom sheet of doc to be easily retrieved. The protrusions (e) are laid beneath & close to the side edge of the doc. This lifts the doc edge up slightly so as to allow the user's fingers to go underneath to pick the doc up. This is complimented by the design of the invention which permits the easy access to one side of the doc [FIG. 1—item (f)]. This is achieved as below:

(i) The vertical side edge (g2) will drop down so that the doc. can easily be accessed to OR

(ii) The vertical side edge (g1) is made low. The vertical side edge (g1) & the wide space (f) between this edge and the doc edge provide enough room for the user's fingers to flick the doc sheets.

The drop down vertical side edge (g2) is folded upwards to enable the invention to closed together.

When the invention is closed together [FIGS. 2a & 2b], it forms a fully enclose case holding the doc inside, protecting these doc from the external environment such as water, etc. Two Locking Devices [FIG. 2a—item (h)] secure the invention together.

The invention has also the ability to stand & stack. When the invention is closed up [FIGS. 2a & 2b], the vertical edges shut together to form the horizontal flat bases on which the invention stands. Stacking is secured by Anti-Slip Studs (male & female) [FIGS. 2a & 2b—item (i)], on which the protrusion of the male stud sits into the depression of the female stud. This allows the invention to stack one after another, without sliding & toppling. These studs also grip the standing invention on its standing position [FIGS. 3a & 3b].

These devices [item (a)-item (i)] act in part or in full to achieve the objective of this invention.

The above invention, coupled with the following features make the invention more user friendly:

a) the invention contains a label to depict the topic & contents of the file and/or;

b) the locking device allows colour coding of the invention and/or;

c) a handle is provided to enable handle carry, where necessary.

1. I claim: a punchless file is made from plastic injection.

2. I claim: a punchless file's size is made slightly larger than the size of doc. A different size of doc will require a different size of the said invention. (ie. a different size of invention is required for A4 or thereabouts, F4 or thereabouts, letter size or thereabouts & legal size or thereabouts. The four vertical edges (walls) of the invention will confine the doc, limiting the movement of the doc.

3. I claim: a punchless file has various devices to hold bulk doc together in a neat & organised manner without the use of ring fitting, lever arch mechanism or post fitting/mechanism for prepunch doc or punch pockets. The devices include
a) a stopper
b) a moveable guide
c) a side guide
d) seperators &/or
e) protrusions that lifts the bottom sheet of doc up slightly for easy retrieval of doc
This is complimented by the design of the invention which permits the easy access to one side of the doc.
These devices act in part or in full to achieve the objective of this invention.

4. I claim: the stopper holds the doc together in a pile & stops the doc from moving through the depth of the invention. The stopper has spring tension which is sufficient to do as mention & yet the tension is light enough for the user to lift the stopper up to insert doc beneath it without the user feeling the hard stiffness of its spring effect.

5. I claim: the design of the invention require the moveable guide. The moveable guide rests against one side of the doc & is adjustable. The doc is kept between the moveable guide & the side guide, thus limiting the movement of the doc sideways(widthwise).

6. I claim: the side guide is fixed & guides one edge of the doc. A portion of the side guide is made higher than the vertical edges of the invention so as to guide a higher pile of doc. The high portion of the side guide is placed at the location where it does not get into the way of accessing the doc & still makes the invention aesthetic.

7. I claim: the lengthwise movement of doc is limited by the vertical edges of the invention.

8. I claim: the seperator is used, when required, to mark the location of the targetted doc. The targetted doc is retrieved & subsequently after usage is put back in its original location with ease, since the seperator is still at this location. The seperator can be put aside when not in use.

9. I claim: Protrusions on the base of the invention facilitate the bottom sheet of doc to be easily retrieved. The protrusions are laid beneath & close to the side edge of the doc. This lifts the doc edge up slightly so as to allow the user's fingers to go underneath to pick the doc up.

10. I claim: the invention is designed to have either a drop down vertical side edge or a low vertical side edge & room between this edge & the doc's edge so that the vertical side edge do not get in the way of the user's fingers when flicking the doc sheets. As the space between the doc edge & the vertical side edge is wide, the moveable guide is required to limit the movement of doc. The drop down vertical side edge is folded upwards to enable the invention to close together.

11. I claim: when the invention is closed together, it forms a fully enclose case holding the doc inside, protecting these doc from the external environment such as water, etc. Two locking devices secure the invention together.

12. I claim: the invention has also the ability to stand & stack. When the invention is closed up, the vertical edges shut together to form the horizontal flat bases on which the invention stands. Stacking is secured by anti-slip studs (male & female), on which the protrusion of the male stud sits into the depression of the female stud. This allows the invention to stack one after another, without sliding & toppling. These studs also grip the standing invention on its standing position.
